(19) United States
(12) Patent Application Publication
(10) Pub. No.: US 2019/0258269 A1
(43) Pub. Date: Aug. 22, 2019

(54) VEHICLE CONTROL DEVICE

(71) Applicant: HONDA MOTOR CO., LTD., Tokyo (JP)

(72) Inventors: Suguru Yanagihara, Wako-shi (JP); Toshifumi Suzuki, Wako-shi (JP); Hiroshi Miura, Wako-shi (JP); Marina Saikyo, Wako-shi (JP)

(21) Appl. No.: 16/277,162

(22) Filed: Feb. 15, 2019

(30) Foreign Application Priority Data
Feb. 16, 2018 (JP) 2018-026305

(51) Int. Cl. G05D 1/02; G06N 5/04; G05D 1/00

(52) U.S. Cl. CPC G05D 1/0289; G05D 1/0223; G05D 1/0088; G06N 5/04

(57) ABSTRACT

If an external environment recognition unit recognizes another vehicle traveling in a particular section ahead of an own vehicle toward the own vehicle, a prediction unit predicts a position where the other vehicle crosses a first travel path (crossing position PA to PD) on the basis of at least one piece of information regarding an entering position of the other vehicle to the particular section, a travel time of the other vehicle in the particular section, a travel distance of the other vehicle in the particular section, a travel state of the other vehicle, and a position of a ground object on a first travel path side.

### CROSS-REFERENCE TO RELATED APPLICATION

This application is based upon and claims the benefit of priority from Japanese Patent Application No. 2018-026305 filed on Feb. 16, 2018, the contents of which are incorporated herein by reference.

### BACKGROUND OF THE INVENTION

### Field of the Invention

The present invention relates to a vehicle control device that controls an own vehicle by predicting a behavior of another vehicle.

### Description of the Related Art

Japanese Laid-Open Patent Publication No. 2013-149053 discloses a device that determines whether a vehicle can finish turning right at an intersection when the vehicle turns right from a first road to a second road in a region where vehicles keep to the left. Specifically, this device performs the determination on the basis of remaining time of a travel permission signal for the first road and vehicle information such as the vehicle speed of the vehicle. In a place including a travel lane for turning right (in some regions, for turning left), the vehicle may turn right (in some regions, turn left) using this travel lane.

### SUMMARY OF THE INVENTION

In some regions, a road including a first travel path and a second travel path, whose traveling directions are opposite, includes a particular section (a yellow lane or a channelizing zone) between the first travel path and the second travel path. In this particular section, vehicles can travel in directions opposite to each other. In such regions, the vehicle traveling in the first travel path needs to perform travel control while monitoring another vehicle traveling in the particular section.

The present invention has been made in view of the above circumstances, and an object is to provide a vehicle control device that can perform travel control appropriately in accordance with another vehicle traveling in a particular section in a place including the particular section on a road.

A vehicle control device according to the present invention includes: an external environment recognition unit configured to recognize a peripheral state of an own vehicle; a prediction unit configured to predict a behavior of another vehicle on the basis of a recognition result from the external environment recognition unit; and a vehicle controller configured to perform travel control of the own vehicle on the basis of a prediction result from the prediction unit, wherein if the external environment recognition unit recognizes the other vehicle traveling in a particular section that is adjacent to a first travel path and a second travel path whose travel direction is different from that of the first travel path, the prediction unit is configured to predict a position where the other vehicle crosses the first travel path on the basis of at least one piece of information regarding an entering position of the other vehicle to the particular section, a travel time of the other vehicle in the particular section, a travel distance of the other vehicle in the particular section, a travel state of the other vehicle, and a position of a ground object on a first travel path side.

In the above structure, the position where the other vehicle traveling in the particular section crosses the first travel path is predicted. Thus, the travel control of the own vehicle can be performed appropriately in accordance with the position.

In the present invention, the prediction unit may predict the position where the other vehicle crosses the first travel path on the basis of at least one piece of information as to whether there is an intersection between the own vehicle and the other vehicle, and information regarding a signal that is expressed by a traffic light provided between the own vehicle and the other vehicle.

In the above structure, more information is used in the prediction. Thus, the position can be predicted with higher reliability.

In the present invention, the vehicle controller may perform speed control for the other vehicle on the basis of a relative speed and/or a relative position between the own vehicle and the other vehicle.

In the above structure, the own vehicle performs the speed control in advance on the basis of the relative speed and/or the relative position. Thus, the own vehicle can travel smoothly.

In the present invention, the external environment recognition unit may recognize whether there is a following vehicle traveling behind the own vehicle, and the vehicle controller may perform the speed control depending on whether there is the following vehicle.

In the above structure, the influence of the speed control of the own vehicle on the travel of the following vehicle can be reduced.

The vehicle control device according to the present invention may further include a notification controller configured to perform notification control for an occupant in the own vehicle, wherein when the own vehicle is traveling in the particular section, if the external environment recognition unit recognizes the other vehicle traveling in the particular section ahead of the own vehicle toward the own vehicle, the notification controller may perform the notification control to notify the occupant that travel of the other vehicle is given priority over travel of the own vehicle.

In the above structure, the other vehicle is given priority for using the particular section. As a result, the traffic flow in the particular section can be made smooth.

In the present invention, when the own vehicle is traveling in the particular section, if the external environment recognition unit recognizes the other vehicle traveling in the particular section ahead of the own vehicle toward the own vehicle, the vehicle controller may cause the own vehicle to move to the first travel path.

In the above structure, the other vehicle can be given priority for using the particular section. As a result, the traffic flow in the particular section can be made smooth.

In the present invention, in a case where the own vehicle enters a target area on a second travel path side from the first travel path by crossing the second travel path, after the external environment recognition unit recognizes that the other vehicle has passed the particular section ahead of the own vehicle, the vehicle controller may cause the own vehicle to move from the first travel path to the particular section, and after a travel along the first travel path in the particular section, the vehicle controller may cause the own vehicle to enter the target area from the particular section.

In the above structure, the other vehicle can be given priority for using the particular section. As a result, the traffic flow in the particular section can be made smooth.

By the present invention, the optimal travel control can be performed depending on presence or absence of the particular section.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram of a vehicle including a vehicle control device according to one embodiment;

FIG. 2 is a function block diagram of a calculation device;

FIG. 3 is a diagram illustrating a plurality of crossing positions that are predicted when another vehicle enters an area on a first travel path side from a second travel path by turning left;

FIG. 4 is a flowchart of a main process to be performed by the vehicle control device according to the present embodiment;

FIG. 5 is a flowchart of a prediction process; and

FIG. 6 is a graph showing predicted probability at each crossing position that varies depending on a travel time of the other vehicle.

### DESCRIPTION OF THE PREFERRED EMBODIMENTS

A preferred embodiment of a vehicle control device according to the present invention will be described in detail with reference to the attached drawings.

### [1. Structure of Own Vehicle 10]

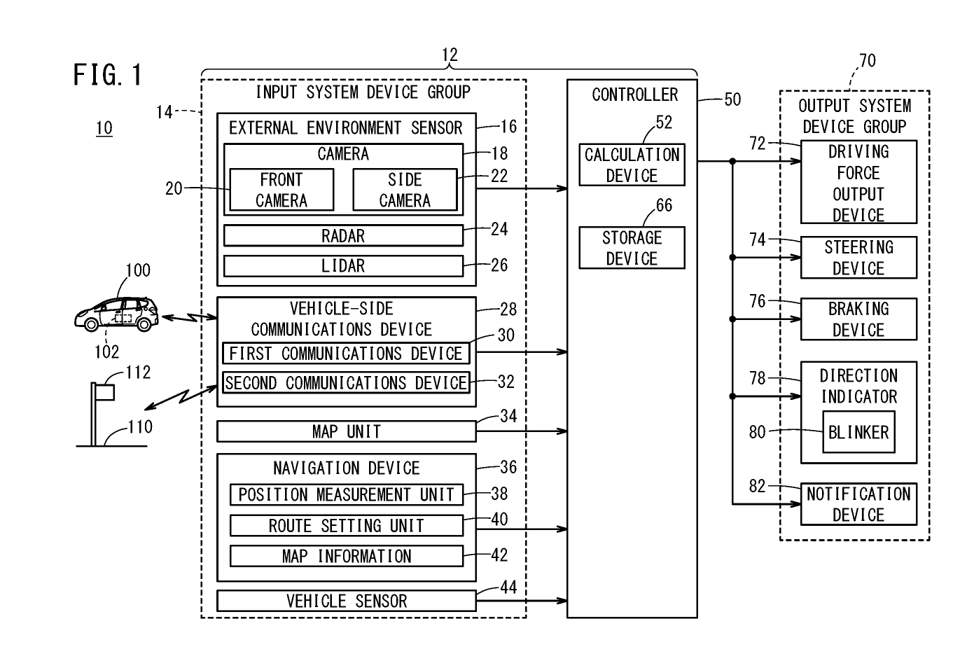

As illustrated in FIG. 1, an own vehicle 10 includes an input system device group 14 that acquires or stores various kinds of information, a controller 50 to which information output from the input system device group 14 is input, and an output system device group 70 that operates in accordance with various instructions output from the controller 50. A vehicle control device 12 according to the present embodiment includes the input system device group 14 and the controller 50. The own vehicle 10 is an automated driving vehicle in which travel control is performed by the controller 50 (including fully automated driving vehicle) or a driving assistance vehicle in which travel control is assisted partially.

### [1.1. Input System Device Group 14]

The input system device group 14 includes an external environment sensor 16, a vehicle-side communications device 28, a map unit 34, a navigation device 36, and vehicle sensors 44. The external environment sensor 16 detects a state of a periphery (external environment) of the own vehicle 10. The external environment sensor 16 includes a plurality of cameras 18 that photographs the external environment, a plurality of radars 24 and one or more LIDARs 26 that detect the distance and the relative speed between the own vehicle 10 and peripheral objects. The cameras 18 include a front camera 20 that photographs an area ahead of the own vehicle 10, and a side camera 22 that photographs a side area of the own vehicle 10. The vehicle-side communications device 28 includes a first communications device 30 and a second communications device 32. The first communications device 30 performs inter-vehicle communications with a communications device 102 provided to another vehicle 100 to acquire external environment information including information regarding the other vehicle 100 (such as a vehicle type, a travel state, or a travel position). The second communications device 32 performs road-vehicle communications with a road-side communications device 112 provided to an infrastructure such as a road 110 to acquire external environment information including the road information (such as information regarding a traffic light or a traffic jam). The map unit 34 stores the number of lanes, the type of lane, the lane width, and the like. The navigation device 36 includes a position measurement unit 38 that measures the position of the own vehicle 10 by a satellite navigation method and/or a self-contained navigation method, map information 42, and a route setting unit 40 that sets a scheduled route from the position of the own vehicle 10 to a destination on the basis of the map information 42. The vehicle sensors 44 detect the travel state of the own vehicle 10. The vehicle sensors 44 include a vehicle speed sensor, an acceleration sensor, a yaw rate sensor, an inclination sensor, a travel distance sensor, and the like, that are not shown.

### [1.2. Output System Device Group 70]

The output system device group 70 includes a driving force output device 72, a steering device 74, a braking device 76, a direction indicator 78, and a notification device 82. The driving force output device 72 includes a driving force output ECU, and a driving source such as an engine or a driving motor. The driving force output device 72 generates driving force in accordance with an occupant's operation of an accelerator pedal or a driving control instruction that is output from the controller 50. The steering device 74 includes an electric power steering system (EPS) ECU and an EPS actuator. The steering device 74 generates a steering force in accordance with an occupant's operation of a steering wheel or a steering control instruction that is output from the controller 50. The braking device 76 includes a braking ECU and a braking actuator. The braking device 76 generates a braking force in accordance with an occupant's operation of a braking pedal or a braking control instruction that is output from the controller 50. The direction indicator 78 includes a blinker ECU and a blinker 80. The direction indicator 78 turns on or off the blinker 80 in accordance with an occupant's operation of a blinker switch and/or an instruction signal for the blinker 80 that is output from the controller 50. The notification device 82 includes a notification ECU and an information transmission device (such as a display device, an acoustic device, or a tactile device). The notification device 82 notifies an occupant in accordance with a notification instruction that is output from the controller 50 or another ECU.

### [1.3. Controller 50]

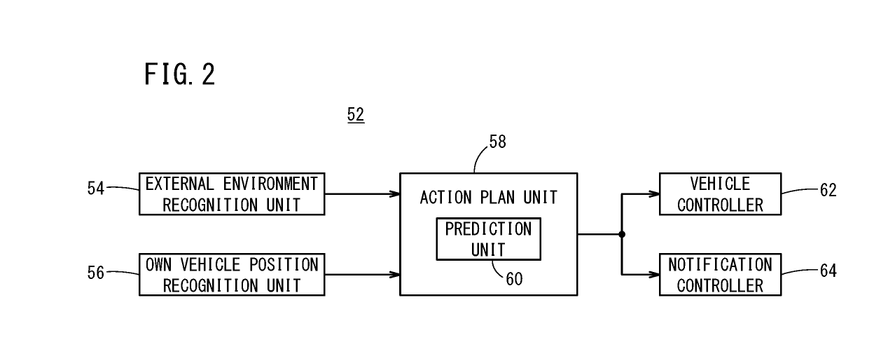

The controller 50 is configured by an ECU, and includes a calculation device 52 such as a processor and a storage device 66 such as a ROM or a RAM. The controller 50 achieves various functions when the calculation device 52 executes programs stored in the storage device 66. As illustrated in FIG. 2, the calculation device 52 functions as an external environment recognition unit 54, an own vehicle position recognition unit 56, an action plan unit 58, a vehicle controller 62, and a notification controller 64.

The external environment recognition unit 54 recognizes the periphery of the own vehicle 10 on the basis of the information output from the external environment sensor 16, the vehicle-side communications device 28, the map unit 34, and the navigation device 36. For example, the external environment recognition unit 54 recognizes the existence, position, size, type, and traveling direction of the other vehicle 100 that travels or stops near the own vehicle 10 and moreover recognizes the distance and the relative speed between the own vehicle 10 and the other vehicle 100, on the basis of image information acquired by the cameras 18, information acquired by the radars 24 and the LIDARs 26, and the external environment information acquired by the first communications device 30. In addition, the external environment recognition unit 54 recognizes the shape and the position of a recognition object included in the road environment (such as the road 110, a lane mark 126, a median strip, or facility or space near the road) on the basis of the image information acquired by the cameras 18, the information acquired by the radars 24 and the LIDARs 26, a high-precision map stored in the map unit 34, the map information 42 stored in the navigation device 36, and the external environment information acquired by the second communications device 32. The external environment recognition unit 54 recognizes a signal of a traffic light (whether travel is allowed or prohibited) on the basis of the image information acquired by the cameras 18 and the external environment information acquired by the second communications device 32.

The own vehicle position recognition unit 56 recognizes the position of the own vehicle 10 on the basis of the information output from the map unit 34 and the navigation device 36.

The action plan unit 58 plans an action that is optimal to the own vehicle 10 on the basis of a recognition result from the external environment recognition unit 54 and the own vehicle position recognition unit 56, and the detected information and stored information of the input system device group 14. For example, the action plan unit 58 predicts a behavior of a moving body (another vehicle 100 or a person) on the basis of the recognition result from the external environment recognition unit 54, plans a behavior of the own vehicle 10 at each time point on the basis of the prediction result, and generates a target travel trajectory and a target speed for achieving the behavior. A prediction unit 60 plays a role of a function that predicts the behavior of the moving body (the other vehicle 100 or person). If a scheduled route is set, the action plan unit 58 plans the action to cause the own vehicle 10 to reach the destination along the scheduled route, and if the scheduled route is not set, the action plan unit 58 plans the action to cause the own vehicle 10 to travel following the current road. The action plan unit 58 plans the action other than the travel control, such as the content of the notification to the occupant, the timing of the notification, and the timing of operating the blinker 80.

The vehicle controller 62 controls the output system device group 70 on the basis of the action planned by the action plan unit 58. For example, the vehicle controller 62 calculates a steering instruction value based on the target travel trajectory generated by the action plan unit 58, and an acceleration/deceleration instruction value based on the target speed, and outputs control instructions to the driving force output device 72, the steering device 74, and the braking device 76. The vehicle controller 62 outputs the instruction of operating the blinker 80 to the direction indicator 78 before the steering.

The notification controller 64 outputs the notification instruction to the notification device 82 on the basis of a notification action planned by the action plan unit 58.

The storage device 66 illustrated in FIG. 1 stores numerals such as thresholds used in comparison, determination, or the like in each process, in addition to various programs to be executed by the calculation device 52.

### [2. Circumstances Assumed in the Present Embodiment]

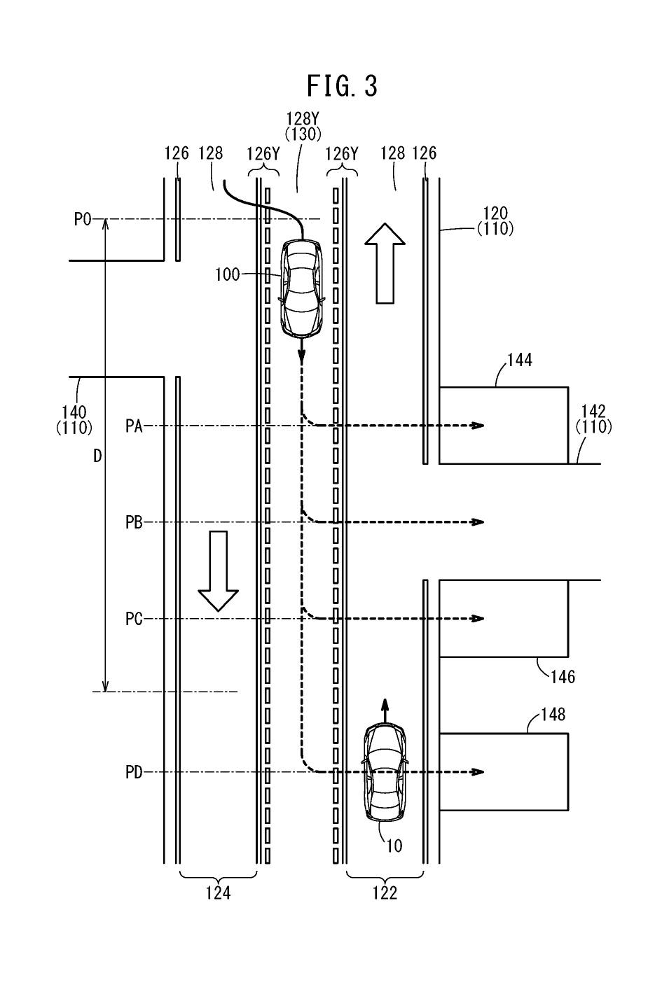

FIG. 3 illustrates a circumstance that is assumed in the present embodiment. In the road 110 illustrated in FIG. 3, vehicles keep to the right. As illustrated in FIG. 3, a first road 120 includes a first travel path 122 and a second travel path 124 in which vehicles travel in opposite (counter) directions. On the second travel path 124 side of the first road 120, there is a second road 140 intersecting with the first road 120, and on the first travel path 122 side, there is a third road 142 intersecting with the first road 120. The first road 120 is a main road, while the second road 140 and the third road 142 are side roads. In addition, beside the first road 120, there are areas (a first area 144, a second area 146, a third area 148) which the vehicle can enter, such as a parking lot along the first travel path 122. Between the first travel path 122 and the second travel path 124 in the first road 120 in FIG. 3, a particular section 130 that is adjacent to both travel paths is provided. The particular section 130 in FIG. 3 is a yellow lane 128Y that is sectioned on both sides in a width direction by two-line lane marks 126Y including a yellow solid line and a yellow dashed line. The yellow lane 128Y is a travel lane 128 that is provided in the road 110 in U.S.A., for example, and allows vehicles to travel in opposite directions. When a vehicle in the first travel path 122 enters an area on the second travel path 124 side by turning left, the vehicle moves to the yellow lane 128Y and travels in the yellow lane 128Y before turning left. When a vehicle in the second travel path 124 enters an area on the first travel path 122 side by turning left, the vehicle turns left by using the yellow lane 128Y similarly. In addition, when a vehicle in the second road 140 enters the first travel path 122 by turning left, the vehicle enters the yellow lane 128Y and travels in the yellow lane 128Y before moving to the travel lane 128 of the first travel path 122. FIG. 3 illustrates crossing positions PA to PD that are predicted when the other vehicle 100 enters the area on the first travel path 122 side (the third road 142, the first area 144, the second area 146, the third area 148) from the second travel path 124 by turning left.

### [3. Operation of Vehicle Control Device 12]

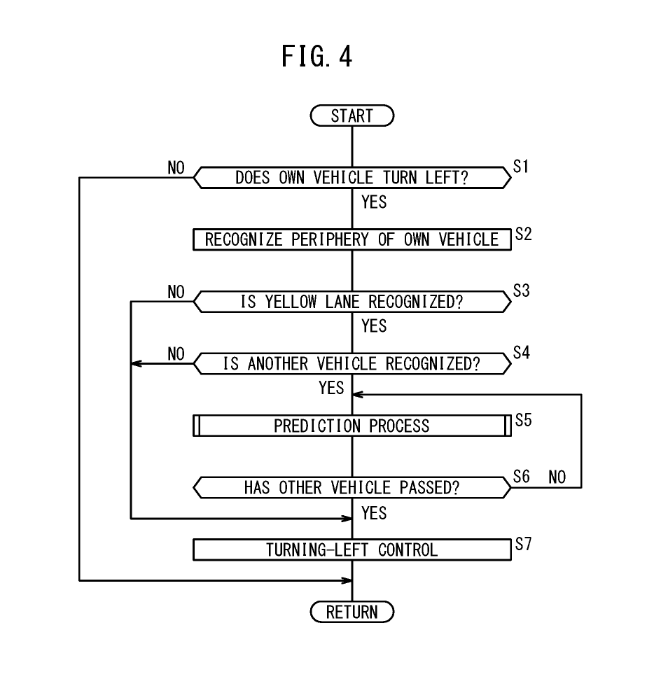

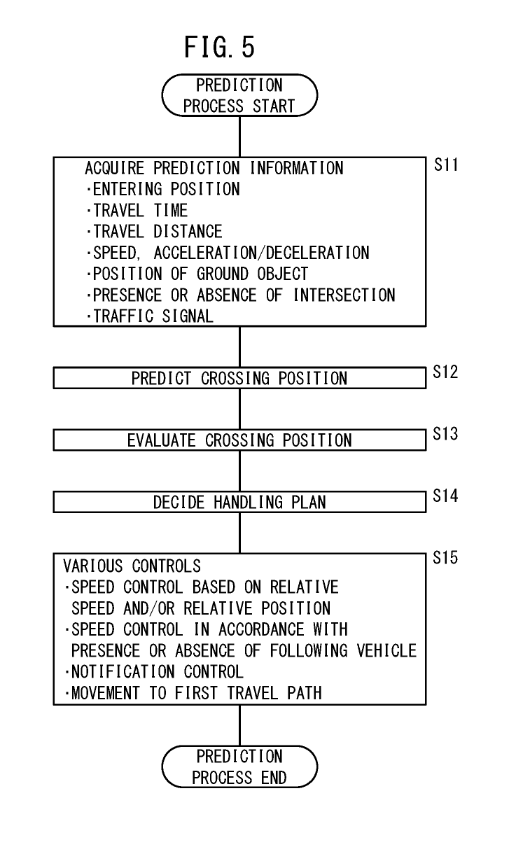

An operation of the vehicle control device 12 is described with reference to FIG. 4 and FIG. 5.

### [3.1. Main Process]

In step S1 of a main process in FIG. 4, the action plan unit 58 determines an event that is generated in the own vehicle 10 on the basis of the position of the own vehicle 10 that is recognized by the own vehicle position recognition unit 56, the map information 42 or the information of the map unit 34, and the scheduled route. As illustrated in FIG. 3, when the own vehicle 10 traveling on the first travel path 122 has approached the second road 140, an event of traveling straight on the first travel path 122 or entering the second road 140 is generated. If the own vehicle 10 enters the second road 140 by turning left (step S1: YES), the process advances to step S2. On the other hand, if the own vehicle 10 does not enter the second road 140 (step S1: NO), a series of processes in FIG. 4 is terminated once.

In step S2, the external environment recognition unit 54 recognizes the periphery of the own vehicle 10, here each travel lane 128 included in the first road 120, on the basis of the latest information output from the input system device group 14. For example, the external environment recognition unit 54 can recognize each travel lane 128 included in the first road 120 on the basis of the map information 42 or the information of the map unit 34.

In addition, the external environment recognition unit 54 can recognize each travel lane 128 included in the first road 120 on the basis of the image information acquired by the cameras 18. In this case, the external environment recognition unit 54 recognizes the lane mark 126 (including the yellow lane mark 126Y) on the basis of the image information. If the travel lane 128 that is sectioned on both sides by the yellow lane marks 126Y or the two-line lane marks 126Y consisting of the inner dashed line and the outer solid line is recognized at a center of the first road 120, this travel lane 128 is recognized as the yellow lane 128Y.

In the case where the yellow lane 128Y exists between the second road 140 and the own vehicle 10 as illustrated in FIG. 3, the external environment recognition unit 54 recognizes the yellow lane 128Y. In this case (step S3: YES), the process advances to step S4. On the other hand, in the case where the yellow lane 128Y does not exist between the second road 140 and the own vehicle 10, the external environment recognition unit 54 does not recognize the yellow lane 128Y. In this case (step S3: NO), the process advances to step S7.

When the process has advanced from step S3 to step S4, the external environment recognition unit 54 recognizes whether there is another vehicle 100 traveling in the yellow lane 128Y toward the own vehicle 10. If the external environment recognition unit 54 recognizes the other vehicle 100 traveling in the yellow lane 128Y (step S4: YES), the process advances to step S5. On the other hand, if the external environment recognition unit 54 does not recognize the other vehicle 100 traveling in the yellow lane 128Y (step S4: NO), the process advances to step S7.

When the process has advanced from step S4 to step S5, a prediction process shown in FIG. 5 is performed. In the prediction process, the crossing positions PA to PD of the other vehicle 100 traveling in the yellow lane 128Y are predicted, and various controls of the own vehicle 10 are performed based on the prediction result. The prediction process will be described in [3.2].

When the prediction process ends, the external environment recognition unit 54 recognizes whether the other vehicle 100 has passed the yellow lane 128Y ahead of the own vehicle 10 in step S6. If the other vehicle 100 has passed the yellow lane 128Y (step S6: YES), the process advances to step S7. On the other hand, if the other vehicle 100 has not passed the yellow lane 128Y (step S6: NO), the process returns to step S5.

When the process has advanced from step S3, step S4, or step S6 to step S7, the action plan unit 58 generates the target speed and the travel trajectory for turning-left control toward the second road 140. If the yellow lane 128Y does not exist, the action plan unit 58 generates the target speed and the travel trajectory that causes the own vehicle 10 to enter the second road 140 directly from the first travel path 122 by turning left. If the yellow lane 128Y exists, the action plan unit 58 generates the target speed and the travel trajectory that causes the own vehicle 10 to move from the first travel path 122 to the yellow lane 128Y and to travel by a predetermined distance or a predetermined time. In addition, the action plan unit 58 generates the target speed and the travel trajectory that causes the own vehicle 10 to enter the second road 140 from the yellow lane 128Y by turning left. The vehicle controller 62 calculates the acceleration/deceleration and the steering amount required for causing the own vehicle 10 to travel along the travel trajectory at the target speed. The driving force output device 72 and the braking device 76 operate in accordance with an acceleration/deceleration instruction that is output from the vehicle controller 62. The steering device 74 operates in accordance with a steering instruction that is output from the vehicle controller 62.

### [3.2. Prediction Process]

When the process has advanced from step S4 to step S5 in FIG. 4, a series of processes illustrated in FIG. 5 is performed. The series of processes is performed repeatedly until the other vehicle 100 passes the yellow lane 128Y ahead of the own vehicle 10 (step S6 in FIG. 4: NO). While the series of processes is performed repeatedly, the external environment recognition unit 54 recognizes the latest external environment information periodically.

In step S11, the prediction unit 60 acquires prediction information. The prediction information includes various pieces of information that are used for predicting a position where the other vehicle 100 traveling in the yellow lane 128Y ahead of the own vehicle 10 toward the own vehicle 10 will cross the first travel path 122. Examples of the prediction information include information regarding an entering position of the other vehicle 100 to the yellow lane 128Y (hereinafter, simply referred to as entering position), a travel time of the other vehicle 100 in the yellow lane 128Y (hereinafter, simply referred to as travel time), a travel distance of the other vehicle 100 in the yellow lane 128Y (hereinafter, simply referred to as travel distance), a travel state of the other vehicle 100 (hereinafter, simply referred to as travel state), and a position of a ground object on the first travel path 122 side. The travel state includes a speed, an acceleration/deceleration, and a yaw rate, for example. In the prediction, one kind of prediction information may be used, or two or more kinds of prediction information may be used. The behavior of the other vehicle 100 is recognized by the external environment recognition unit 54, and the information regarding the behavior is stored in the storage device 66. Thus, the information regarding the entering position, the travel distance, and the travel time among the prediction information described above can be recognized based on the information stored in the storage device 66. The travel distance is expressed by a distance from an entering position P0 where the other vehicle 100 enters the yellow lane 128Y to the latest travel position. The travel time is expressed by a time from a time point when the other vehicle 100 enters the yellow lane 128Y to the present time.

The prediction information can include, in addition to each piece of prediction information described above, information as to whether there is an intersection between the own vehicle 10 and the other vehicle 100 (hereinafter, simply referred to as presence or absence of intersection) or information regarding a signal that is expressed by the traffic light provided between the own vehicle 10 and the other vehicle 100 (hereinafter, simply referred to traffic signal), for example.

In step S12, the prediction unit 60 predicts the position where the other vehicle 100 will cross the first travel path 122 (crossing position). The crossing position is predicted based on the travel position of the other vehicle 100 and the position of the ground object on the first travel path 122 side which the vehicle can enter. In FIG. 3, the crossing position PA to the first area 144, the crossing position PB to the third road 142, the crossing position PC to the second area 146, and the crossing position PD to the third area 148 are predicted. It is assumed that the other vehicle 100 should travel by a distance D in the yellow lane 128Y. Then, the crossing position PA to the crossing position PC are within the distance D from the entering position P0. The crossing position PD is over the distance D from the entering position P0.

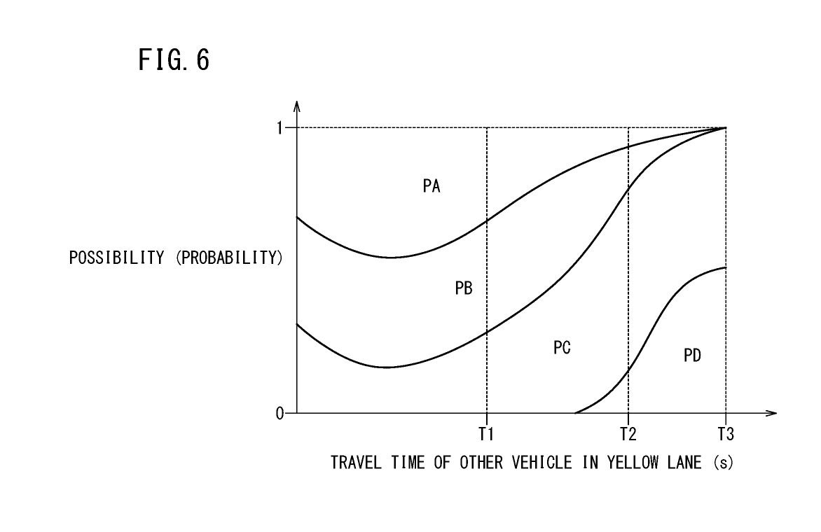

In step S13, the prediction unit 60 evaluates the validity of each of the crossing positions PA to PD on the basis of each piece of information acquired in step S11. First, on the basis of the prediction information, the prediction unit 60 calculates a target travel pattern in which the other vehicle 100 turns left smoothly at each of the predicted crossing positions PA to PD, for example, a variation pattern of the travel state as the travel time or the travel distance increases. Then, the prediction unit 60 successively acquires the travel state of the other vehicle 100, and quantitatively evaluates the coincidence between the present travel state or the future travel state and the target travel state at the corresponding travel time or travel distance. For example, as illustrated in FIG. 6, by performing normalization so that the total of evaluation values for all the crossing positions PA to PD becomes one, the evaluation values can be processed as the crossing probability. This evaluation may employ a mathematical expression including a function, or a deterministic model using an artificial intelligence.

In addition, the probability can be changed by using the information regarding the presence or absence of the intersection or the information regarding the traffic signal. For example, on the premise that the probability that the other vehicle 100 turns left at the intersection is high, the probability of the crossing position at the intersection may be increased to some extent. Moreover, when the vehicle speed of the other vehicle 100 is less than a predetermined speed at the position that is distant from the traffic light by a predetermined distance although the traffic signal expresses a travel permission signal, the probability of the crossing position between the other vehicle 100 and the traffic light may be increased to some extent.

In step S14, the prediction unit 60 decides a handling plan on the basis of the evaluation in step S13. For example, the prediction unit 60 decides a position for the handling (prediction position), such as any one of the crossing positions PA to PD, an intermediate position between the crossing position PA and the crossing position PB, an intermediate position between the crossing position PB and the crossing position PC, or an intermediate position between the crossing position PC and the crossing position PD.

In step S15, the action plan unit 58 plans the various types of control in accordance with the handling plan. The vehicle controller 62 and/or the notification controller 64 performs the various types of control in accordance with the plan. Specific examples of the various control types are described below. One control type of the specific examples may be performed, or a plurality of control types may be performed.

### [3.3. Specific Examples of Various Control Types]

The action plan unit 58 plans speed control for the other vehicle 100 on the basis of the distance from the own vehicle 10 to the position for the handling, and the relative speed and/or the relative position (relative distance) between the own vehicle 10 and the other vehicle 100 traveling in the yellow lane 128Y. The storage device 66 stores a map. The input parameters of the map are the distance from the own vehicle 10 to the position of the handling plan, and the relative speed and/or the relative position (relative distance) between the own vehicle 10 and the other vehicle 100, and the output value of the map is the target speed. The action plan unit 58 generates the target speed by using this map. The vehicle controller 62 calculates the acceleration/deceleration on the basis of the target speed, and outputs the acceleration/deceleration instruction to the driving force output device 72 and the braking device 76.

The external environment recognition unit 54 recognizes whether the other vehicle 100 traveling behind the own vehicle 10 (following vehicle) is present. The action plan unit 58 plans the speed control in accordance with the presence or absence of the following vehicle when the deceleration is needed. For example, if the following vehicle is recognized and the inter-vehicle distance to the following vehicle is less than a predetermined distance, the target speed is generated while the decelerated speed and/or the deceleration is limited. On the other hand, if the following vehicle is not recognized or the inter-vehicle distance to the following vehicle is more than or equal to the predetermined distance, the target speed is generated without limiting the decelerated speed or the deceleration. The vehicle controller 62 calculates the deceleration on the basis of the target speed, and outputs a deceleration instruction to the driving force output device 72 and the braking device 76.

If the own vehicle 10 is currently traveling in the yellow lane 128Y, the action plan unit 58 plans the notification action for the occupant. The notification controller 64 outputs the notification instruction to notify the occupant that the travel of the other vehicle 100 is given priority over the travel of the own vehicle 10.

If the own vehicle 10 is currently traveling in the yellow lane 128Y, the action plan unit 58 generates the target speed and the travel trajectory that causes the own vehicle 10 to move to the first travel path 122 temporarily. The vehicle controller 62 calculates the acceleration/deceleration and the steering amount on the basis of the travel trajectory and the target speed, and outputs the acceleration/deceleration instruction to the driving force output device 72 and the braking device 76 and outputs the steering instruction to the steering device 74.

The driving force output device 72 and the braking device 76 operate in accordance with the acceleration/deceleration instruction that is output from the vehicle controller 62. Moreover, the steering device 74 operates in accordance with the steering instruction that is output from the vehicle controller 62. Furthermore, the notification device 82 operates in accordance with the notification instruction that is output from the notification controller 64.

### [4. Modifications]

The particular section 130 may be other section than the yellow lane 128Y. For example, the particular section 130 may be a channelizing zone (marking) provided on the road 110 in Japan etc. In this case, the external environment recognition unit 54 recognizes the presence or absence of a zone having a stripe pattern surrounded by a white solid line (called a “zebra zone”).

In the above embodiment, the present invention is applied to a scene where the target area which the own vehicle 10 enters by crossing the second travel path 124 is the second road 140. Additionally, the present invention is also applicable to a scene where the target area is a parking lot or the like beside the second travel path 124 and the vehicle in the first travel path 122 enters the parking lot or the like by crossing the second travel path 124.

In some cases, the external environment information acquired by the vehicle-side communications device 28 includes the information indicating the presence or absence of the yellow lane 128Y but excludes the detailed positional information. In such cases, the action plan unit 58 may assume that the yellow lane 128Y exists in the first road 120 on the basis of the external environment information, and generate the virtual yellow lane 128Y before performing various controls.

In the above embodiment, it is assumed that the own vehicle 10 travels in the first travel path 122.

Additionally, the present invention is also applicable to a scene where the own vehicle 10 enters the yellow lane 128Y from an area beside the first travel path 122 or an area beside the second travel path 124.

### [5. Summary of the Present Embodiment]

The vehicle control device 12 includes: the external environment recognition unit 54 configured to recognize the peripheral state of the own vehicle 10; the prediction unit 60 configured to predict the behavior of the other vehicle 100 on the basis of the recognition result from the external environment recognition unit 54; and the vehicle controller 62 configured to perform the travel control of the own vehicle 10 on the basis of the prediction result from the prediction unit 60. If the external environment recognition unit 54 recognizes the other vehicle 100 traveling in the particular section 130 (yellow lane 128Y) that is adjacent to the first travel path 122 and the second travel path 124 whose travel direction is different from that of the first travel path 122, the prediction unit 60 is configured to predict the position where the other vehicle 100 crosses the first travel path 122 (crossing positions PA to PD) on the basis of at least one piece of the information regarding the entering position P0 of the other vehicle 100 to the particular section 130, the travel time of the other vehicle 100 in the particular section 130, the travel distance of the other vehicle 100 in the particular section 130, the travel state of the other vehicle 100, and the position of the ground object on the first travel path 122 side.

In the above structure, the position where the other vehicle 100 traveling in the particular section 130 crosses the first travel path 122 is predicted. Thus, the travel control of the own vehicle 10 can be performed appropriately in accordance with the position.

The prediction unit 60 is configured to predict the position where the other vehicle 100 crosses the first travel path 122 on the basis of at least one piece of the information as to whether there is the intersection between the own vehicle 10 and the other vehicle 100, and the information regarding the signal that is expressed by the traffic light provided between the own vehicle 10 and the other vehicle 100.

In the above structure, more information is used in the prediction. Thus, the position can be predicted with higher reliability.

The vehicle controller 62 is configured to perform the speed control considering the other vehicle 100 on the basis of the relative speed and/or the relative position between the own vehicle 10 and the other vehicle 100.

In the above structure, the own vehicle 10 performs the speed control in advance on the basis of the relative speed and/or the relative position. Thus, the own vehicle 10 can travel smoothly.

The external environment recognition unit 54 is configured to recognize whether there is the following vehicle (other vehicle 100) traveling behind the own vehicle 10, and the vehicle controller 62 is configured to perform the speed control depending on presence or absence of the following vehicle.

In the above structure, the influence of the speed control of the own vehicle 10 on the travel of the following vehicle can be reduced.

The vehicle control device 12 further includes the notification controller 64 configured to perform the notification control for the occupant in the own vehicle 10. While the own vehicle 10 is traveling in the particular section 130, if the external environment recognition unit 54 recognizes the other vehicle 100 traveling in the particular section 130 ahead of the own vehicle 10 toward the own vehicle 10, the notification controller 64 is configured to perform the notification control to notify the occupant that the travel of the other vehicle 100 is given priority over the travel of the own vehicle 10.

In the above structure, the other vehicle 100 can be given priority for using the particular section 130. As a result, the traffic flow in the particular section 130 can be made smooth.

While the own vehicle 10 is traveling in the particular section 130, if the external environment recognition unit 54 recognizes the other vehicle 100 traveling in the particular section 130 ahead of the own vehicle 10 toward the own vehicle 10, the vehicle controller 62 is configured to cause the own vehicle 10 to move to the first travel path 122.

In the above structure, the other vehicle 100 can be given priority for using the particular section 130. As a result, the traffic flow in the particular section 130 can be made smooth.

In the case where the own vehicle 10 enters the target area (second road 140) on the second travel path 124 side from the first travel path 122 by crossing the second travel path 124, after the external environment recognition unit 54 recognizes that the other vehicle 100 has passed the particular section 130 ahead of the own vehicle 10, the vehicle controller 62 is configured to cause the own vehicle 10 to move from the first travel path 122 to the particular section 130, and subsequently, after the travel along the first travel path 122 in the particular section 130, the vehicle controller 62 is configured to cause the own vehicle 10 to enter the target area from the particular section 130.

In the above structure, the other vehicle 100 can be given priority for using the particular section 130. As a result, the traffic flow in the particular section 130 can be made smooth.

The vehicle control device according to the present invention is not limited to the embodiment above, and can employ various structures without departing from the gist of the present invention.

What is claimed is:

1. A vehicle control device comprising:
an external environment recognition unit configured to recognize a peripheral state of an own vehicle;
a prediction unit configured to predict a behavior of another vehicle on a basis of a recognition result from the external environment recognition unit; and
a vehicle controller configured to perform travel control of the own vehicle on a basis of a prediction result from the prediction unit, wherein if the external environment recognition unit recognizes the other vehicle traveling in a particular section that is adjacent to a first travel path and a second travel path whose travel direction is different from that of the first travel path, the prediction unit is configured to predict a position where the other vehicle crosses the first travel path on a basis of at least one piece of information regarding an entering position of the other vehicle to the particular section, a travel time of the other vehicle in the particular section, a travel distance of the other vehicle in the particular section, a travel state of the other vehicle, and a position of a ground object on a first travel path side.

2. The vehicle control device according to claim 1, wherein the prediction unit is configured to predict the position where the other vehicle crosses the first travel path on a basis of at least one piece of information as to whether there is an intersection between the own vehicle and the other vehicle, and information regarding a signal that is expressed by a traffic light provided between the own vehicle and the other vehicle.

3. The vehicle control device according to claim 1, wherein the vehicle controller is configured to perform speed control considering the other vehicle on a basis of a relative speed and/or a relative position between the own vehicle and the other vehicle.

4. The vehicle control device according to claim 3, wherein:
the external environment recognition unit is configured to recognize whether there is a following vehicle traveling behind the own vehicle; and
the vehicle controller is configured to perform the speed control depending on presence or absence of the following vehicle.

5. The vehicle control device according to claim 1, further comprising a notification controller configured to perform notification control for an occupant in the own vehicle,
wherein while the own vehicle is traveling in the particular section, if the external environment recognition unit recognizes the other vehicle traveling in the particular section ahead of the own vehicle toward the own vehicle, the notification controller is configured to perform the notification control to notify the occupant that travel of the other vehicle is given priority over travel of the own vehicle.

6. The vehicle control device according to claim 1, wherein while the own vehicle is traveling in the particular section, if the external environment recognition unit recognizes the other vehicle traveling in the particular section ahead of the own vehicle toward the own vehicle, the vehicle controller is configured to cause the own vehicle to move to the first travel path.

7. The vehicle control device according to claim 3, wherein in a case where the own vehicle enters a target area on a second travel path side from the first travel path by crossing the second travel path, after the external environment recognition unit recognizes that the other vehicle has passed the particular section ahead of the own vehicle, the vehicle controller is configured to cause the own vehicle to move from the first travel path to the particular section, and subsequently, after a travel along the first travel path in the particular section, the vehicle controller is configured to cause the own vehicle to enter the target area from the particular section.
